(19) United States
(12) Patent Application Publication
(10) Pub. No.: US 2003/0051946 A1
(43) Pub. Date: Mar. 20, 2003

(54) Vehicle lift

(76) Inventors: Ying-Ming Chen, Taichung (TW); Kai-Chin Fan, Taichung (TW)

Correspondence Address: Ying-Ming Chen, 58, MA YUAN WEST ST., TAICHUNG, TW

(21) Appl. No.: 09/950,353

(22) Filed: Sep. 5, 2001

(51) Int. Cl. B66F 7/06

(52) U.S. Cl. 187/211

(57) ABSTRACT

A vehicle lift has a base crossbar, a top crossbar, an oil cylinder, a motor, and a pair of support frames. The top crossbar has a slot to receive an upper end of one of the support frames. A motor is connected to the top crossbar. The oil cylinder is disposed between the base crossbar and the top crossbar. Each of the support frames is disposed between the base crossbar and the top crossbar.

### BACKGROUND OF THE INVENTION

The present invention relates to a vehicle lift. More particularly, the present invention relates to a vehicle lift which prevents a vehicle from theft.

A car thief often opens car locks and steals a car easily. Most car locks cannot protect a car from theft.

### SUMMARY OF THE INVENTION

An object of the present invention is to provide a vehicle lift which has a theftproof function.

Accordingly, a vehicle lift comprises a base crossbar, a top crossbar, an oil cylinder, a motor, and a pair of support frames. The top crossbar has a slot to receive an upper end of one of the support frames. A motor is connected to the top crossbar to drive the oil cylinder. The oil cylinder is disposed between the base crossbar and the top crossbar. Each of the support frames is disposed between the base crossbar and the top crossbar.

### BRIEF DESCRIPTION OF THE DRAWINGS

FIG. 1 is a schematic view illustrating a vehicle lift of a preferred embodiment disposed on a bottom of a front bumper of a vehicle;

FIG. 2 is a schematic view illustrating a vehicle lift of a preferred embodiment disposed on a bottom of a rear bumper of a vehicle;

FIG. 3 is a schematic view illustrating two vehicle lifts of a preferred embodiment disposed on a bottom of a front bumper of a vehicle and a bottom of a rear bumper of the vehicle;

FIG. 4 is an elevational view of a vehicle lift of a preferred embodiment in accordance with the present invention;

FIG. 4A is a schematic view illustrating a vehicle lift of a preferred embodiment is folded;

FIG. 5 is a front elevational view of a vehicle lift of a preferred embodiment in accordance with the present invention;

FIG. 5A is a side elevational view of a vehicle lift of a preferred embodiment in accordance with the present invention;

FIG. 6 is an elevational view of a vehicle lift of another preferred embodiment in accordance with the present invention; and

FIG. 6A is a schematic view illustrating a vehicle lift of another preferred embodiment is folded.

### DETAILED DESCRIPTION OF THE INVENTION

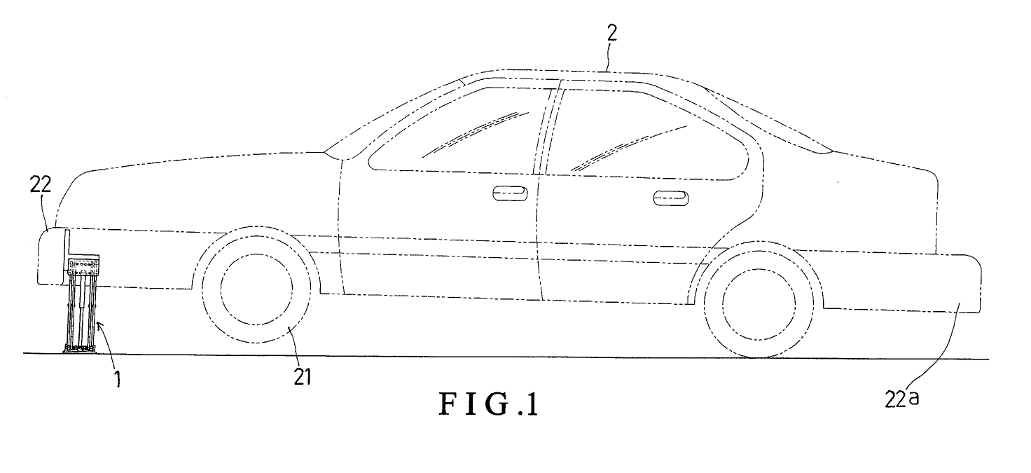

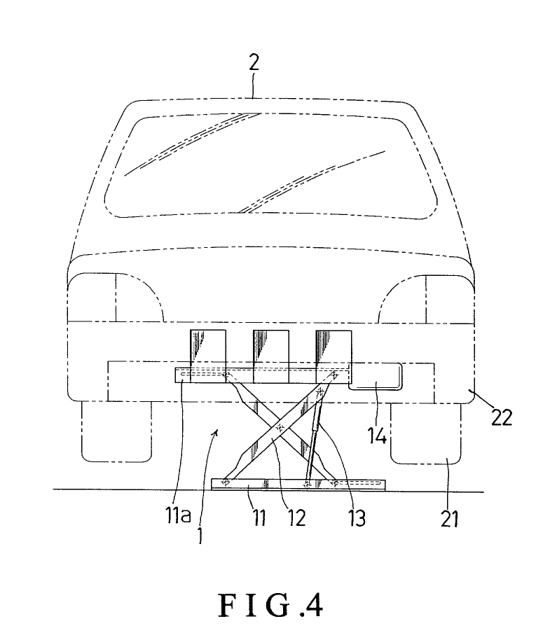

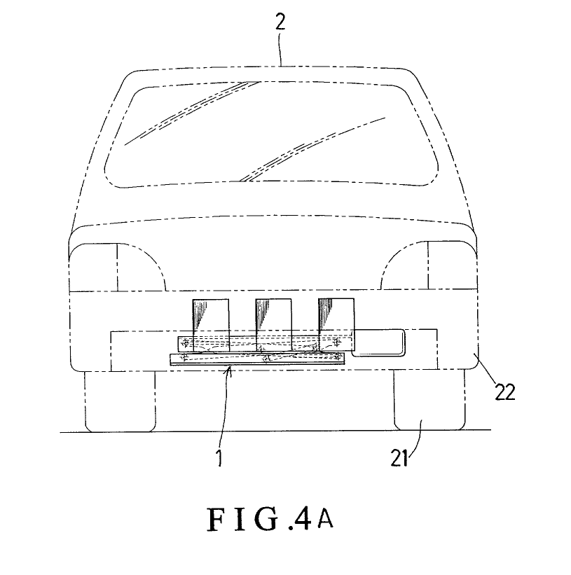

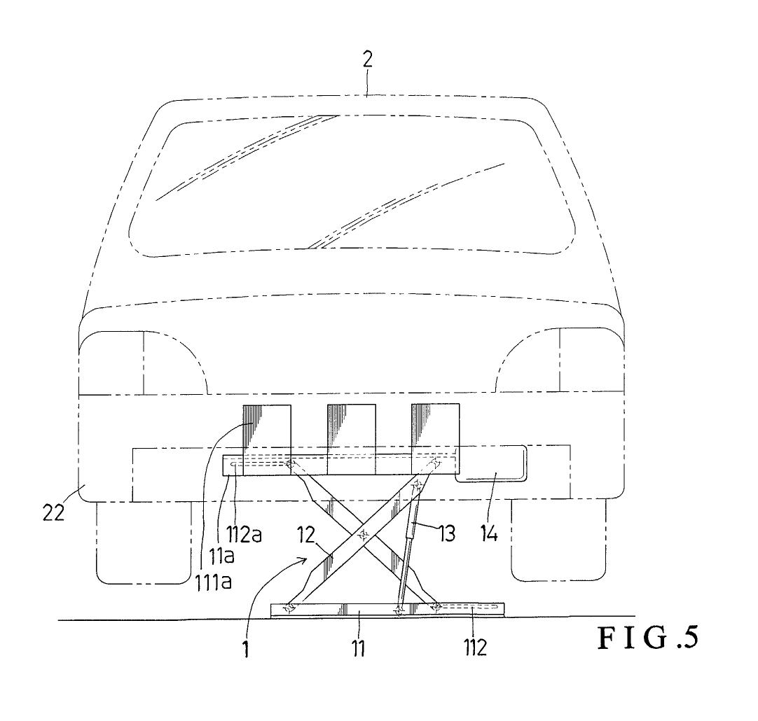

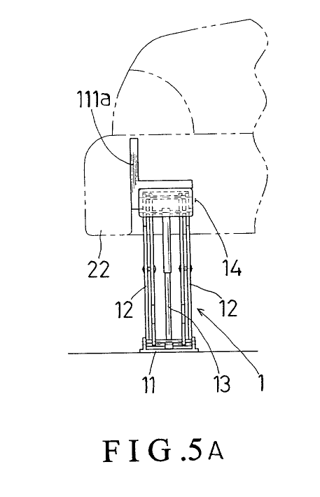

Referring to FIGS. 1 to 5A first, a vehicle lift 1 comprises a base crossbar 11, a top crossbar 11a, an oil cylinder 13, a motor 14, and a pair of support frames 12.

The top crossbar 11a has a slot 112a to receive an upper end of one of the support frames 12.

A motor 14 is connected to the top crossbar 11a in order to drive the oil cylinder 13.

The oil cylinder 13 is disposed between the base crossbar 11 and the top crossbar 11a.

Each of the support frames 12 is disposed between the base crossbar 11 and the top crossbar 11a.

Each of the support frames 12 is in an X shape.

A car 2 has a front bumper 22, a rear bumper 22a, at least a front wheel 21, and at least a rear wheel 21a. A plurality of positioning frames 111a are disposed on the front bumper 22 to support the top crossbar 11a.

Referring to FIG. 1 again, the vehicle lift 1 is disposed on a bottom of the front bumper 22 of the car 2.

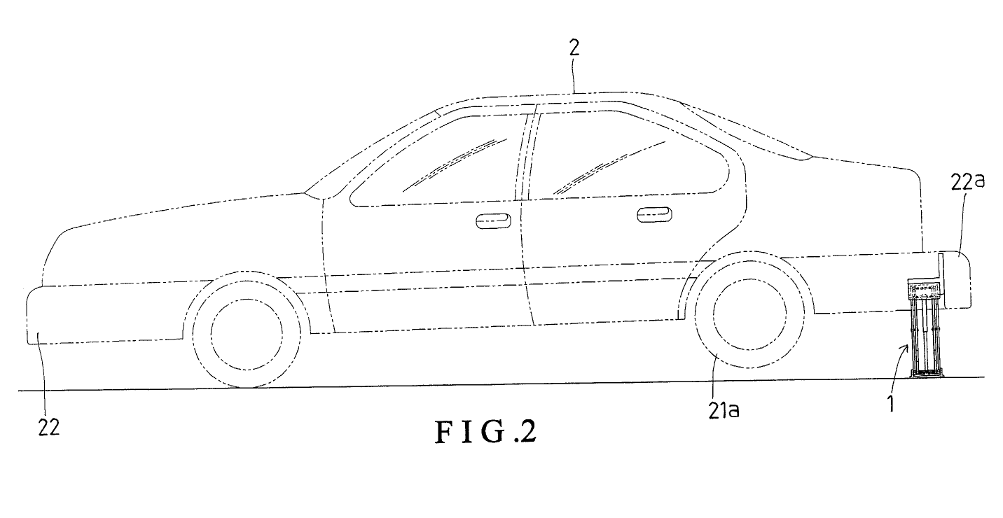

Referring to FIG. 2 again, the vehicle lift 1 is disposed on a bottom of the rear bumper 22a of the car 2.

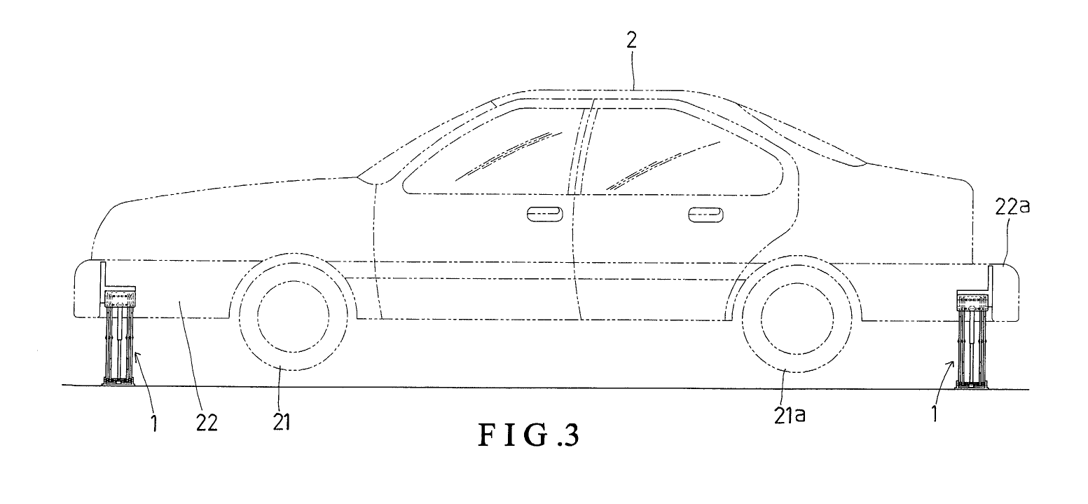

Referring to FIG. 3 again, two vehicle lifts 1 are disposed on a bottom of a front bumper 22 of the car 2 and a bottom of a rear bumper 22a of the car 2.

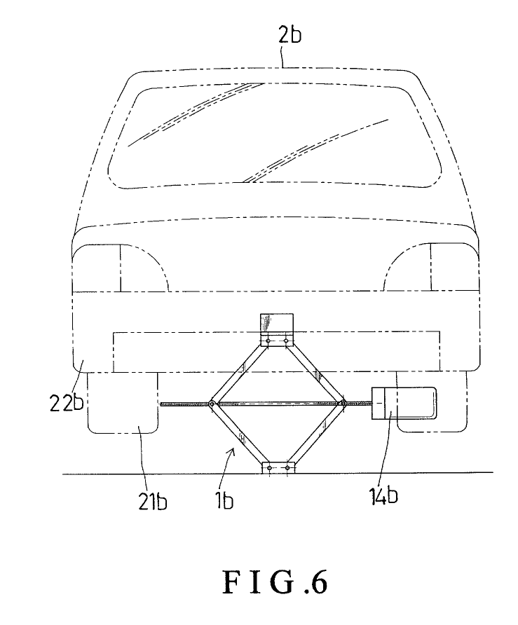

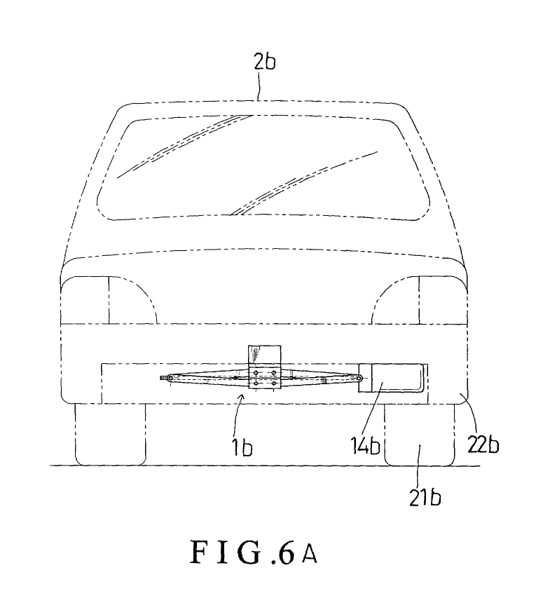

Referring to FIGS. 6 and 6A, another vehicle lift 1b is driven by a motor 14b.

A car 2b has a front bumper 22b and two front wheels 21b. The vehicle lift 1b is Referring to FIG. 6 again, the vehicle lift 1b is disposed on a bottom of the front bumper 22b of the car 2b. The vehicle lift 1b is extended.

Referring to FIG. 6A again, the vehicle lift 1b is folded.

The invention is not limited to the above embodiment but various modification thereof may be made. Further, various changes in form and detail may be made without departing from the scope of the invention.

I claim:

1. A vehicle lift comprises:
a base crossbar, a top crossbar, an oil cylinder, a motor, and a pair of support frames,
the top crossbar having a slot to receive an upper end of one of the support frames,
a motor connected to the top crossbar to drive the oil cylinder,
the oil cylinder disposed between the base crossbar and the top crossbar, and
each of the support frames disposed between the base crossbar and the top crossbar.

2. The vehicle lift as claimed in claim 1, wherein each of the support frames is in an X shape.
